(19) United States
(12) Patent Application Publication
(10) Pub. No.: US 2010/0323879 A1
(43) Pub. Date: Dec. 23, 2010

(54) METHOD FOR REGENERATING PALLADIUM-CONTAINING METAL SUPPORTED CATALYST, PALLADIUM-CONTAINING METAL SUPPORTED CATALYST AND METHOD FOR PRODUCING THE SAME

(75) Inventors: Naoko Yamada, Hiroshima (JP); Koichi Mizutani, Hiroshima (JP); Seiichi Kawatou, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Rayon Co. Ltd, Tokyo (JP)

(21) Appl. No.: 12/521,626

(22) PCT Filed: Dec. 26, 2007
(86) PCT No.: PCT/JP2007/074885

§ 371 Date: Jul. 24, 2010

(30) Foreign Application Priority Data
Dec. 28, 2006 (JP) 2006 355862
Nov. 22, 2007 (JP) 2007 303163

(51) Int. Cl. B01J 38/60; B01J 38/12; B01J 23/44

(52) U.S. Cl. 502/27; 502/38; 502/339

(57) ABSTRACT

Disclosed is a method for regenerating a palladium-containing metal supported catalyst which has been used for production of an α,β-unsaturated carboxylic acid from an olefin or an α,β-unsaturated aldehyde. Specifically disclosed is a method for regenerating a palladium-containing metal supported catalyst which has been used for production of an α,β-unsaturated carboxylic acid by oxidation of an olefin or an α,β-unsaturated aldehyde with molecular oxygen in a liquid phase, which comprises a step of calcining a palladium-containing metal supported catalyst after use at a temperature in a range of from 150 to 700° C. in the presence of molecular oxygen to convert at least a part of palladium into palladium oxide, and a step of reducing the palladium oxide thus obtained in the calcining step.

### TECHNICAL FIELD

The present invention relates to a method for regenerating a palladium-containing metal supported catalyst which has been used for production of an α,β-unsaturated carboxylic acid from an olefin or an α,β-unsaturated aldehyde.

### BACKGROUND ART

As a noble metal-containing supported catalyst for production of an α,β-unsaturated carboxylic acid through liquid-phase oxidation of an olefin or an α,β-unsaturated aldehyde, for example, a palladium-containing catalyst is proposed in Patent Document 1, and a catalyst containing palladium and tellurium is proposed in Patent Document 2. A method for producing a palladium-containing metal supported catalyst, in which palladium oxide contained in a catalyst precursor in a state of being supported on a carrier is reduced, is proposed in Patent Document 3.

Generally speaking, a catalyst is liable to be deteriorated in its performance while it is repeatedly used or used for a long time. The term “being deteriorated” specifically means, for example, sublimation and scattering of catalyst components, phase transition, phase separation, chemical change in which a solid-phase reaction advances, physical change in which sintering or change of specific surface area or pore structure occurs, adsorption of catalyst poison to active sites, poisoning attributed to reaction, accumulation of coke, inhibition of gas diffusion caused by covering with an inorganic solid substance, or mechanical fracture caused by wear and breakage. As for the aforementioned palladium-containing metal supported catalyst, productivity of an α,β-unsaturated carboxylic acid as a product is also lowered by such a deterioration and continuous use of the catalyst becomes difficult from the economical viewpoint. In addition, it is economically disadvantageous to replace the deteriorated catalyst with a new one, and it is preferable to regenerate the deteriorated catalyst.

However, there is no description about a method for regenerating a catalyst in Patent Documents 1 to 3, and development of a method for regenerating a palladium-containing metal supported catalyst for production of an α,β-unsaturated carboxylic acid has been desired.

As a method for regenerating a deteriorated palladium-containing metal supported catalyst, for example, a method of heat treatment of the catalyst under a condition where there is no oxygen existing, namely, an atmosphere of methanol and nitrogen followed by reduction with hydrogen is proposed in Patent Document 4.

Patent Document 1: Japanese Patent Application Laid-Open No. Sho 56-59,722
Patent Document 2: International Publication No. WO 2005/118,134

### Patent Document 3: Japanese Patent Application Laid-Open No. 2006-167,709

Patent Document 4: Japanese Patent Publication No. Hei 2-20,293

### DISCLOSURE OF INVENTION

### Problem to be Solved by the Invention

However, there is a problem such that performance of a catalyst is not sufficiently recovered by the method for regenerating a catalyst described in Patent Document 4, and a more efficient method has been desired.

It is an object of the present invention to provide a method for effectively regenerating a palladium-containing metal supported catalyst which has been used for production of an α,β-unsaturated carboxylic acid from an olefin or an α,β-unsaturated aldehyde.

### Means for Solving the Problem

The present invention is a method for regenerating a palladium-containing metal supported catalyst which has been used for production of an α,β-unsaturated carboxylic acid by oxidation of an olefin or an α,β-unsaturated aldehyde with molecular oxygen in a liquid phase, the method comprising the steps of:

calcining the palladium-containing metal supported catalyst after use at a temperature in a range of from 150 to 700° C. in the presence of molecular oxygen to convert at least a part of palladium into palladium oxide; and
reducing the palladium oxide thus obtained in the calcining step.

Further, the present invention is a method for regenerating a palladium-containing metal supported catalyst which has been used for production of an α,β-unsaturated carboxylic acid by oxidation of an olefin or an α,β-unsaturated aldehyde with molecular oxygen in a liquid phase, the method comprising the steps of:

subjecting the palladium-containing metal supported catalyst after use to a mineral acid treatment;
calcining the palladium-containing metal supported catalyst thus treated in the mineral acid treatment step at a temperature in a range of from 150 to 700° C. in the presence of molecular oxygen; and
reducing a palladium oxide thus obtained in the calcining step.

Further, the present invention is a method for producing a palladium-containing metal supported catalyst to be used for production of an α,β-unsaturated carboxylic acid by oxidation of an olefin or an α,β-unsaturated aldehyde with molecular oxygen in a liquid phase, the method comprising regenerating a palladium-containing metal supported catalyst after use using the aforementioned method for regenerating the palladium-containing metal supported catalyst.

Further, the present invention is a palladium-containing metal supported catalyst to be obtained by the aforementioned method for producing a palladium-containing metal supported catalyst, in which a relative deviation of influence sphere of metal particles being supported on a carrier is 88% or less.

Further, the present invention is a palladium-containing metal supported catalyst for production of an α,β-unsaturated carboxylic acid by oxidation of an olefin or an α,β-unsaturated aldehyde with molecular oxygen in a liquid phase, in which a relative deviation of influence sphere of metal particles being supported on a carrier is 88% or less.

### EFFECT OF THE INVENTION

According to the present invention, a palladium-containing metal supported catalyst which has been used for production of an α,β-unsaturated carboxylic acid from an olefin or an α,β-unsaturated aldehyde can be effectively regenerated.

### BEST MODE FOR CARRYING OUT THE INVENTION

The present invention is a method for regenerating a palladium-containing metal supported catalyst which has been used for production of an α,β-unsaturated carboxylic acid by oxidation of an olefin or an α,β-unsaturated aldehyde with molecular oxygen in a liquid phase, which comprises the steps of calcining the palladium-containing metal supported catalyst after use at a temperature in a range of from 150 to 700° C. in the presence of molecular oxygen to convert at least a part of palladium into palladium oxide, and reducing the palladium oxide thus obtained in the calcining step.

The palladium-containing metal supported catalyst to be regenerated by the method of the present invention contains palladium, which is a noble metal, as an essential component, however, it may contain, as a second metal component besides palladium, a noble metal or a metal component other than noble metals. The noble metal as the second metal component includes platinum, rhodium, ruthenium, iridium, gold, silver, and osmium. Among them, platinum, rhodium, ruthenium, and silver are preferably used. In addition, the metal component other than noble metals as the second metal component includes, for example, antimony, tellurium, thallium, lead, and bismuth. Among them, antimony, tellurium, lead, molybdenum, and bismuth are preferably used. These second metal components can be used alone or in a combination of two or more kinds. It is preferable from the viewpoint of realization of a high catalyst activity that palladium be 50% by mass or more among the metal components contained in the palladium-containing metal supported catalyst.

In addition, in the above-mentioned palladium-containing metal supported catalyst of the present invention, the metal components are supported on a carrier. As the carrier, for example, an activated carbon, silica, alumina, magnesia, calcia, titania, and zirconia can be mentioned. Among them, silica, titania, and zirconia are preferably used. These carriers can be used alone or in a combination of two or more kinds, each of which is the same kind or a different kind and has different physical properties. A preferable specific surface area of the carrier cannot be absolutely fixed because it is variable depending on a kind of the carrier, however, it is preferably 50 to 1,500 m²/g and more preferably 100 to 1,000 m²/g in the case of silica.

A loading ratio of palladium to a carrier is preferably 0.1 to 40% by mass based on a mass of the carrier before it is loaded with palladium, more preferably 0.5 to 30% by mass, and furthermore preferably 1 to 20% by mass.

Although a catalyst to be regenerated by the method of the present invention is the palladium-containing metal supported catalyst which has been used for production of an α,β-unsaturated carboxylic acid, preparation of a fresh catalyst, which is a palladium-containing metal supported catalyst, to be used at the beginning for production of an α,β-unsaturated carboxylic acid can be carried out with a publicly known method, for example, the one described in Patent Document 3. Hereinafter, a preferable method of preparation for the fresh catalyst will be explained, however, the scope and object of the present invention are not limited to those in which the fresh catalyst prepared by this method is used.

The palladium-containing metal supported catalyst can be produced, for example, by loading of a palladium compound as a raw material on a carrier at first followed by reduction in a solvent. When a second metal component is caused to be contained, a metal compound such as a salt or an oxide of the second metal component as a raw material may be caused to coexist in the solvent.

The palladium compound to be used as a raw material is not particularly limited, however, it is preferably, for example, chlorides, acetates, nitrates, sulfates, tetraammine complexes, and acetylacetonato complexes of palladium, and more preferably acetates, nitrates, tetraammine complexes, and acetylacetonato complexes of palladium.

The solvent for dissolution of the palladium compound is not particularly limited as long as it can dissolve the palladium compound, and for example, water, inorganic acids, alcohols, ketones, organic acids, organic acid esters, and hydrocarbons can be used as the solvent. As the inorganic acids, for example, nitric acid and hydrochloric acid can be mentioned. As the alcohols, for example, tertiary butanol and cyclohexanol can be mentioned. As the ketones, for example, acetone, methyl ethyl ketone, and methyl isobutyl ketone can be mentioned. As the organic acids, for example, acetic acid, propionic acid, n-butyric acid, isobutyric acid, n-valeric acid, and isovaleric can be mentioned. As the organic acid esters, for example, ethyl acetate and methyl propionate can be mentioned. As the hydrocarbons, for example, hexane, cyclohexane, and toluene can be mentioned. Among them, water, the inorganic acids, and the organic acids are preferable. These solvents can be used alone or as a mixture of two or more kinds.

As a method for loading the palladium compound on the carrier, a method in which the carrier is soaked in a solution of the palladium compound and then the solvent is evaporated, or what is called a pore filling method in which an amount of a solution of the palladium compound equivalent to a pore volume of the carrier is absorbed by the carrier and then the solvent is evaporated is preferable. Note that, a method in which a solution of the palladium compound is sprayed on the carrier heated, or a method in which additives are added in a solution of the palladium compound may also be used.

In addition, it is preferable to carry out heat treatment after loading the palladium compound on the carrier. At least a part of the palladium compound is decomposed to be converted into palladium oxide, namely a catalyst precursor, by the heat treatment. A temperature of the heat treatment is preferably the decomposition temperature of the palladium compound used or higher. Specifically, it is preferable to set the temperature of the heat treatment of the palladium compound as a temperature at which 10% by mass of the palladium compound is lost when the palladium compound is heated at a rate of 5.0° C. per minute in an air flow from the room temperature using a thermogravimeter or higher. The temperature of the heat treatment cannot be absolutely fixed because it is variable depending on a kind of the palladium compound to be used, however, it is preferably about 150 to 600° C. A time for the heat treatment is not particularly limited as long as it is enough for the transformation of the palladium compound to palladium oxide, however, it is preferably 1 to 12 hours. A method for the heat treatment is not particularly limited, and a static method and a rotational method can be mentioned as the method for the heat treatment.

The palladium-containing metal supported catalyst can be obtained by reduction of the catalyst precursor thus produced.

A reducing agent to be used for the reduction is not particularly limited, and for example, hydrazine, formaldehyde, sodium borohydride, hydrogen, formic acid, a formate salt, ethylene, propylene, 1-butene, 2-butene, isobutylene, 1,3-butadien, 1-heptene, 2-heptene, 1-hexene, 2-hexene, cyclohexene, allyl alcohol, methallyl alcohol, 1,2-ethanediol, acrolein, and methacrolein can be mentioned. Among them, hydrogen, hydrazine, formaldehyde, formic acid, a formate salt, and 1,2-ethanediol are preferable. These reducing agents can also be used in a combination of two or more kinds.

When the reducing agent is a gas, a device for carrying out the reduction of the catalyst precursor is not particularly limited, and for example, it is possible to carry out the reduction by passing the reducing agent through the catalyst precursor.

In addition, when the reducing agent is a liquid, a device for carrying out the reduction of the catalyst precursor is not particularly limited, and for example, it is possible to carry out the reduction by adding the reducing agent into a slurry in which the catalyst precursor is dispersed. In this case, an amount of the reducing agent to be used is not particularly limited, however, it is preferably 1 mole or more and preferably 100 moles or less to 1 mole of the palladium compound used as a raw material.

A reduction temperature and a reduction time are variable depending on the palladium compound or the reducing agent to be used, however, the reduction temperature is preferably −5 to 150° C. and more preferably 15 to 80° C. The reduction time is preferably 0.1 to 4 hours, more preferably 0.25 to 3 hours, and furthermore preferably 0.5 to 2 hours.

When the palladium-containing metal supported catalyst is soaked or wet with a liquid as in the case where the reduction has been carried out using a liquid reducing agent, it is also possible to separate the catalyst from the liquid by a solid-liquid separation means such as filtration, centrifugation, sedimentation, or drying. The solid-liquid separation means may be a combination of two or more measures such as filtration under suction followed by drying.

When the palladium-containing metal supported catalyst containing the second metal component is produced, a loading method thereof is not particularly limited, and it is possible to cause a metal compound such as a salt or an oxide corresponding to the second metal component to coexist in a solution of palladium, or it is also possible to load the second metal component before the palladium compound is loaded or after the palladium compound has been loaded. Further, it is also possible to load the second metal component after the palladium compound has been loaded and reduced.

It is preferable to carry out washing of the palladium-containing metal supported catalyst thus obtained with water or an organic solvent. Impurities derived from the metal compound as a raw material such as chloride, acetate group, nitrate group, or sulfate group can be removed by the washing with water or the organic solvent. A method for washing and a number of times of washing are not particularly limited, however, it is preferable to carry out washing to the extent that the impurities can be sufficiently removed because the liquid-phase oxidation reaction of an olefin or an α,β-unsaturated aldehyde is liable to be inhibited depending on the impurities. The catalyst thus washed may be used in the reaction after it is recovered by filtration or centrifugation.

In addition, the recovered catalyst may be dried. The method for drying is not particularly limited, however, it is preferable that the catalyst be dried in air or in an inert gas using a dryer. The dried catalyst can be activated prior to the use in the reaction, if necessary. A method for activation is not particularly limited, however, for example, a method of heat treatment under a reductive atmosphere in a hydrogen flow can be mentioned. According to this method, an oxidized film on the surface of palladium and impurities that have not been removed by washing can be removed.

In the next place, a method for producing an α,β-unsaturated carboxylic acid using a fresh palladium-containing metal supported catalyst obtained by the above-mentioned method will be explained. The production of the α,β-unsaturated carboxylic acid can be carried out by a publicly known method such as the one described in Patent Document 2.

In the method for producing the α,β-unsaturated carboxylic acid, a reaction of oxidizing an olefin or an α,β-unsaturated aldehyde as a raw material with molecular oxygen in a liquid phase to form the α,β-unsaturated carboxylic acid is carried out in the presence of the palladium-containing metal supported catalyst. It is preferable to carry out the reaction in the presence of a fresh palladium-containing metal supported catalyst if this reaction is carried out before the regeneration method of the present invention, which will be mentioned later, is carried out, however, the reaction may be carried out in the presence of a used catalyst whose performance has been lowered by the use in a liquid-phase oxidation reaction, or in the presence of a catalyst which has been regenerated by a method other than that of the present invention. The reaction can also be carried out in the presence of a regenerated palladium-containing metal supported catalyst if this reaction is carried out after the regeneration method of the present invention is carried out. In that case, for example, the fresh palladium-containing metal supported catalyst, the used catalyst whose performance has been lowered by the use in the liquid-phase oxidation reaction, or the catalyst which has been regenerated by a method other than that of the present invention can also be caused to coexist.

As the olefin as a raw material for an α,β-unsaturated carboxylic acid, for example, propylene, isobutylene, and 2-butene can be mentioned. In addition, as the α,β-unsaturated aldehyde, for example, acrolein, methacrolein, crotonaldehyde, namely β-methyl acrolein, and cinnamaldehyde, namely β-phenyl acrolein can be mentioned. The olefin or α,β-unsaturated aldehyde as a raw material may contain a small amount of at least one of a saturated hydrocarbon and a lower saturated aldehyde as impurities.

When the raw material is an olefin, the α,β-unsaturated carboxylic acid to be produced has the same carbon skeleton as the olefin, and when the raw material is an α,β-unsaturated aldehyde, the α,β-unsaturated carboxylic acid to be produced is the one in which the aldehyde group in the α,β-unsaturated aldehyde has changed into the carboxyl group. Specifically, acrylic acid is obtained when the raw material is propylene or acrolein and methacrylic acid is obtained when the raw material is isobutylene or methacrolein.

As a source of molecular oxygen to be used in the liquid-phase oxidation reaction, air is economical and hence preferable, however, pure oxygen or a mixed gas of pure oxygen and air can also be used, and if necessary, a diluted mixed gas in which air or pure oxygen is diluted with nitrogen, carbon dioxide, water vapor, or the like can also be used. The gas such as air is supplied in a pressurized state into a reactor such as autoclave.

A solvent to be used in the liquid-phase oxidation reaction is not particularly limited, and for example, water, alcohols, ketones, organic acids, organic acid esters, and hydrocarbons can be used. As the alcohols, for example, tertiary butanol and cyclohexanol can be mentioned. As the ketones, for example, acetone, methyl ethyl ketone, and methyl isobutyl ketone can be mentioned. As the organic acids, for example, acetic acid, propionic acid, n-butyric acid, isobutyric acid, n-valeric acid, and isovaleric can be mentioned. As the organic acid esters, for example, ethyl acetate and methyl propionate can be mentioned. As the hydrocarbons, for example, hexane, cyclohexane, and toluene can be mentioned. Among these solvents, organic acids having 2 to 6 carbon atoms, ketones having 3 to 6 carbon atoms, and tertiary butanol are preferable. These solvents can be used alone or as a mixture of two or more kinds. Further, when at least one kind selected from the group consisting of alcohols, ketones, organic acids, and organic acid esters is used, it is preferable to use it as a mixed solvent with water. In this case, the quantity of water in the mixed solvent is not particularly limited, however, it is preferably 2 to 70% by mass and more preferably 5 to 50% by mass to the mass of the mixed solvent. The mixed solvent is preferably homogeneous, however, it is possible to use it in an inhomogeneous state.

The liquid-phase oxidation reaction may be carried out either in a continuous manner or in a batchwise manner, however, it is preferably in a continuous manner, from the viewpoint of industrial productivity.

The amount of the olefin or α,β-unsaturated aldehyde, which is a raw material of the liquid-phase oxidation reaction, to be used is preferably 0.1 to 20 parts by mass based on 100 parts by mass of the solvent, and more preferably 0.5 to 10 parts by mass.

The amount of molecular oxygen to be used is preferably 0.1 to 30 parts by mass based on 1 part by mass of the olefin or α,β-unsaturated aldehyde, which is a raw material, more preferably 0.3 to 25 parts by mass, and furthermore preferably 0.5 to 20 parts by mass.

The catalyst is usually used in a suspended state in a reaction liquid in which the liquid-phase oxidation reaction is carried out, however, it may be used in a fixed bed. The amount of the catalyst to be used is preferably 0.1 to 30 parts by mass as the catalyst existing in the reactor based on 100 parts by mass of the solution existing in the reactor, more preferably 0.5 to 20 parts by mass, and furthermore preferably 1 to 15 parts by mass.

A reaction temperature and a reaction pressure for carrying out the liquid-phase oxidation reaction are properly selected depending on a solvent and a raw material of the reaction to be used. The reaction temperature is preferably 30 to 200° C. and more preferably 50 to 150° C. The reaction pressure is preferably 0 to 10 MPa in gauge pressure, hereinafter all pressures being expressed in gauge pressure, and more preferably 2 to 7 MPa.

It is preferable that the used catalyst whose performance have been lowered by the use in a liquid-phase oxidation reaction, which is referred to as a “spent catalyst”, hereinafter, be washed with a washing solvent to remove substances adhering to the catalyst prior to a regeneration treatment after being separated from the reaction liquid. As the preferable washing solvent, for example, water, alcohols, ketones, organic acids, organic acid esters, and hydrocarbons can be mentioned. Further, the spent catalyst may be dried. A drying is preferably carried out at 20 to 200° C. under a normal pressure or reduced pressure. As a drying atmosphere, inert gases or gases such as air other than the inert gases can be used.

In the regeneration treatment of the above-mentioned spent catalyst, calcination treatment is carried out at first and followed by reduction treatment. The calcination treatment is carried out in the presence of molecular oxygen. At least a part of palladium can be converted into palladium oxide by this calcination treatment. It is preferable to carry out the calcination treatment so as to convert all the palladium into palladium oxide. A method for the calcination treatment is not particularly limited, and a static method and a rotational method can be mentioned. Calcination treatment temperature is chosen in the range of 150 to 700° C., and is more preferably 250 to 450° C., furthermore preferably 280 to 420° C., and particularly preferably 300 to 400° C. As the calcination treatment temperature becomes higher, substances adsorbed on the catalyst surface can be more sufficiently removed, and as the calcination treatment temperature becomes lower, an increase in average particle diameter of the metals in the catalyst can be more suppressed. In addition, as the calcination treatment temperature becomes lower, vaporization of the second metal component becomes smaller. Calcination treatment time is preferably 0.5 to 60 hours and more preferably 1 to 20 hours.

It is also possible to subject the spent catalyst to a mineral acid treatment prior to the calcination treatment. Namely, the spent catalyst is soaked into a mineral acid, and subjected to heat treatment in this state, if necessary. As the mineral acid to be used, hydrofluoric acid, hydrochloric acid, hydrobromic acid, hydroiodic acid, nitric acid, sulfuric acid, phosphoric acid, perchloric acid, and hydroperiodic acid are preferable. The mineral acid can also be used in a state of an aqueous solution, and a concentration of the aqueous mineral acid solution is preferably 1 to 80% by mass and more preferably 5 to 70% by mass. The amount of the mineral acid or the aqueous mineral acid solution to be added may be such that the catalyst can be almost sufficiently soaked in it, and the optimum amount is variable depending on a carrier to be used, however, it is preferably 2 to 5 times as much as the pore volume of the carrier. Temperature for the mineral acid treatment is preferably 5 to 100° C. Time for the mineral acid treatment is preferably 0.1 to 10 hours and more preferably 0.5 to 5 hours. Additives such as water, organic acids, ethers, ketones, and alcohols, may be added after the mineral acid treatment, if necessary. It is possible to dry the catalyst by filtrating or vaporizing a dispersion medium of the catalyst such as the mineral acid.

Note that, when the mineral acid treatment is carried out prior to the calcination treatment, the subject of the calcination treatment is the spent catalyst thus subjected to the mineral acid treatment. The calcination treatment temperature is preferably 180 to 450° C. and more preferably 200 to 400° C.

As a source of molecular oxygen to be used in the aforementioned calcination treatment, air is economical and hence preferable, however, pure oxygen, a mixed gas of pure oxygen and air, or a diluted mixed gas in which air or pure oxygen is diluted with nitrogen, carbon dioxide, water vapor, or the like can also be used.

After the aforementioned calcination treatment, palladium oxide obtained by the calcination treatment is subjected to reduction treatment. If there remains a palladium compound, the palladium compound is also subjected to the reduction treatment at the same time. A reducing agent to be used at the time of reduction is not particularly limited as long as it is a reductive material, and for example, hydrazine, formaldehyde, sodium borohydride, hydrogen, formic acid, a formate salt, ethylene, propylene, 1-butene, 2-butene, isobutylene, 1,3-butadien, 1-heptene, 2-heptene, 1-hexene, 2-hexene, cyclohexene, allyl alcohol, methallyl alcohol, 1,2-ethanediol, acrolein, and methacrolein can be mentioned. Among them, hydrazine, formaldehyde, hydrogen, formic acid, a formate salt, propylene, allyl alcohol, and 1,2-ethanediol are preferable and hydrazine, formaldehyde, formic acid, a formate salt, and 1,2-ethanediol are more preferable. These reducing agents can also be used in a combination of two or more kinds.

When the reducing agent is a gas, it is possible to carry out the reduction treatment by passing the reducing agent through the spent catalyst after the calcination treatment. In this case, the amount of the reducing agent to be used is not particularly limited, however, it is preferably 1 mole or more and 100 moles or less based on 1 mole of palladium in the spent catalyst.

In addition, when the reducing agent is a liquid, it is possible to carry out the reduction treatment by adding the reducing agent into a slurry in which the spent catalyst after the calcination treatment is dispersed. In this case, the amount of the reducing agent to be used is not particularly limited, it is preferably 1 mole or more and 100 moles or less based on 1 mole of palladium in the spent catalyst.

A reduction temperature and a reduction time are variable depending on the reducing agent to be used, however, the reduction temperature is preferably −5 to 150° C. and more preferably 15 to 80° C. The reduction time is preferably 0.1 to 4 hours, more preferably 0.25 to 3 hours, and furthermore preferably 0.5 to 2 hours.

There is a case where average particle diameter of the metals in the spent catalyst is increased as compared with that in the fresh catalyst. In addition, in the case that the catalyst contains at least one second metal component besides palladium, there is a case where a surface compositional ratio of the second metal component (M) to palladium (Pd) as a metal, namely M/Pd represented in molar ratio, varies. However, by regenerating the spent catalyst using the above-mentioned method, it is possible to cause the average particle diameter of the metals in the spent catalyst, which has been increased, to decrease to come near to that in the catalyst before use, namely the fresh catalyst, and it is possible to improve dispersibility of the metal particles on the carrier. In addition, in the case that the catalyst contains the second metal component, it is possible to cause the surface compositional ratio of the spent catalyst to come near to that in the catalyst before use, namely the fresh catalyst, besides the above effects.

The reason why the average particle diameter of the metals in the spent catalyst can be caused to come near to that in the fresh catalyst by the regeneration treatment is presumably that, when palladium in a metal state is once converted into palladium oxide by molecular oxygen through the calcination treatment and reduced to the metal state again by the reducing agent, palladium is redispersed. In addition, the reason why the surface compositional ratio of the spent catalyst can be caused to come near to that in the fresh catalyst is presumably that there are atomic movements of the metal components at the time of calcination treatment.

Further, these effects are also thought to be caused by the mineral acid treatment. Namely, as follows: Metal particles in the catalyst are once dissolved in the mineral acid by the mineral acid treatment and an increase in average particle diameter of the metals in the catalyst is cancelled; then, palladium in a metal state is redispersed when it is once converted into a metal oxide by molecular oxygen; further, a crystal structure in the catalyst is reconstructed by reduction treatment, so that the average particle diameter of the metals in the catalyst is decreased. In addition, in the case that the catalyst contains the second metal component, it is presumed that an alloy phase be formed and the second metal component be moved into the inside by atomic movements at the time of calcination treatment, though details are unclear.

Besides, the average particle diameter of the metals in the catalyst is preferably 1.0 to 8.0 nm and more preferably 2.0 to 7.0 nm.

In addition, a preferable compositional ratio of surface layer as a catalyst, namely M/Pd represented in molar ratio, is variable depending on a second metal component to be used and cannot be absolutely fixed, however, it is preferably 0.02 to 0.30 and more preferably 0.05 to 0.25.

The productivity of an α,β-unsaturated carboxylic acid can be improved by the regeneration treatment mentioned so far of the spent catalyst.

It is preferable that dispersibility of the metal particles in the palladium-containing metal supported catalyst obtained by the regeneration treatment be higher. In the present invention, it is possible to further improve the dispersibility by carrying out the mineral acid treatment. The relative deviation of influence sphere of metal particles, which is an index of particle dispersibility of the metal particles, is preferably 95% or less, more preferably 90% or less, and particularly preferably 88% or less. It is possible to produce a catalyst having a relative deviation of influence sphere of metal particles of 88% or less by subjecting the spent catalyst to the mineral acid treatment, to calcination treatment, and to reduction treatment. Such a catalyst cannot be obtained by conventional production methods of fresh catalysts. This relative deviation of influence sphere of metal particles can be calculated as follows.

An ultra-thin section as a sample is prepared, and observed with a transmission electron microscope and images of 5 fields of view or more are taken. These images taken are analyzed with an image-processing software to obtain a mean and a standard deviation of influence sphere of metal particles. A relative deviation is determined by dividing the standard deviation by the mean thus obtained.

### EXAMPLES

Hereinafter, the present invention will be more concretely explained by examples and comparative examples, however, the present invention is not limited to these examples. In the following examples and comparative examples, “part” means “part by mass”.

### (Measurement of XPS Spectra)

Compositional ratio of surface layer of the metal components in the catalyst was measured with X-ray Photoelectron Spectroscopy (XPS).

A more specific method for the measurement will be shown below.

A powder sample was ground with an agate mortar. The resultant powder sample was coated on a conductive carbon tape and placed at a position where x-ray is irradiated in an X-ray Photoelectron Spectroscopy apparatus (ESCA LAB220iXL (trade name), manufactured by VG Scientific Ltd.). Al Kα line from a monochromatic line source was irradiated on this sample and photoelectrons emitted from the sample were collected to obtain XPS spectra.

### (Calculation of a Molar Ratio (M/Pd) of the Second Metal Component (M) to Palladium Metal in a Surface Layer of a Catalyst)

The ratio was estimated from a ratio of peak areas in the XPS spectra of the second metal component and palladium metal, both existing in the surface layer of the catalyst. Specifically, atomic % of each element was calculated from a peak area ratio of each element using an analysis software (Eclips (trade name)). Note that, the total of the atomic % of each element contained in the catalyst was set as 100. The ratio of the second metal component (M) to palladium metal was taken from the calculated atomic % to determine the molar ratio (M/Pd).

### (Measurement of Average Particle Diameter of Metals in a Catalyst)

Measurement of average particle diameter of metals in a catalyst was carried out with a transmission electron microscope (TEM), and particle diameters of metals were estimated from obtained images to calculate an average particle diameter thereof.

An example of a more specific method for the measurement will be shown below.

A sample catalyst was embedded in a polypropylene-made capsule using Suppr Resin method and an ultra-thin section was made with microtome (ULTRACUT-S (trade name), manufactured by Leica Microsystems GmbH). This section was observed with a transmission electron microscope (H-7600 (trade name), manufactured by Hitachi, Ltd.) and images of 5 fields of view were taken. For each image thus taken, particle diameters of 100 or more metal particles were measured using an image-processing software, Image Pro Plus (trade name). The average value of particle diameter of metals thus obtained was determined as an average particle diameter of metals.

### (Measurement of a Relative Deviation of Influence Sphere of Metal Particles)

The same procedure was carried out as the one in “Measurement of average particle diameter of metals in a catalyst” to take images of 5 fields of view. The images thus taken were analyzed with an image-processing software, Image Pro Plus (trade name), to obtain a mean and a standard deviation of influence sphere of metal particles. The relative deviation was determined by dividing the standard deviation by the mean thus obtained.

### (Analysis of Raw Materials and Products in Production of an α,β-Unsaturated Carboxylic Acid)

Analysis of raw materials and products in production of an α,β-unsaturated carboxylic acid was carried out with gas chromatography. Selectivity to the α,β-unsaturated carboxylic acid to be produced and productivity of the α,β-unsaturated carboxylic acid to be produced are defined as follows.

Selectivity to the α,β-unsaturated carboxylic acid (%)=(A/B)×100

Productivity of the α,β-unsaturated carboxylic acid (g/(g×h))=C/(D×E)

In the above formulae, A represents a number of moles of the α,β-unsaturated carboxylic acid produced, B represents a number of moles of an olefin reacted, C represents a mass (g) of the α,β-unsaturated carboxylic acid produced, D represents a mass (g) of a noble metal contained in a catalyst used, and E represents a reaction time (h).

### Reference Example 1

### Preparation of a Fresh Catalyst

To 215.8 parts of palladium (II) nitrate nitric acid solution in which palladium content is 23.14% by mass, which is equivalent to 50 parts of palladium, 16.2 parts of telluric acid dissolved in a small amount of pure water and 500 parts of pure water were added to prepare a mixed solution, in which a charging molar ratio of Te/Pd was 0.15. In the above-mentioned mixed solution, 250 parts of a silica carrier having a specific surface area of 450 m²/g and a pore volume of 0.68 cc/g were soaked, and the solvent was evaporated at 40° C. for 3 hours under a reduced pressure using an evaporator. Subsequently, heat treatment at 200° C. for 3 hours in air was carried out. To a catalyst precursor thus obtained, 500 parts of 37% by mass aqueous formaldehyde solution was added. The resultant mixture was heated to 70° C., held at the same temperature for 2 hours while stirred, filtrated under suction, and washed with pure water to obtain a palladium-containing metal supported catalyst. Palladium loading ratio of this catalyst was 20% by mass.

### (Evaluation of Physical Properties of a Fresh Catalyst)

Evaluation of physical properties of a fresh catalyst was carried out using the aforementioned methods. The Te/Pd in the surface layer of the catalyst was 0.21 and the average particle diameter of metals in the catalyst was 4.8 nm.

### (Evaluation by a Batchwise Reaction)

To an autoclave, 3.0 parts of the palladium-containing metal supported catalyst obtained by the above-mentioned method and 100 parts of 75% by mass aqueous t-butanol solution as a reaction solvent were added, and the autoclave was shut tight. Subsequently, 6.5 parts of isobutylene was introduced, and stirring of the resultant mixture was started at a number of revolution of 1,000 rpm and a temperature of the mixture was raised to 90° C. After the raising of the temperature was completed, nitrogen was introduced into the autoclave to the internal pressure of 2.4 MPa and then compressed air was introduced into the autoclave to the internal pressure of 4.8 MPa. Each time when the internal pressure dropped by 0.15 MPa, oxygen was introduced into the autoclave to raise the internal pressure by 0.1 MPa, and this operation was repeated during a reaction. After the tenth introduction of oxygen, when the internal pressure dropped by 0.15 MPa, the reaction was finished. At this time, the reaction time was 77 minutes.

After the reaction was finished, the inside of the autoclave was cooled in an ice bath. A gas-sampling bag was attached to a gas outlet of the autoclave and the gas outlet was opened and emerging gas was collected while the internal pressure of the reactor was released. The reaction liquid containing catalyst was taken out from the autoclave and the catalyst was separated by membrane filter and only the reaction liquid was recovered. The recovered reaction liquid and the collected gas were analyzed with gas chromatography. The results are shown in Table 1.

### (Continuous Reaction)

The above-mentioned evaluation of the reaction was carried out in a batchwise manner for a short time, so that the catalyst is deteriorated only slightly. Therefore, the reaction was carried out in a continuous manner and a spent catalyst of this reaction was used for the evaluation in order to clarify regeneration effect of the catalyst. The method for reaction in the continuous manner is as follows.

A fresh palladium-containing metal supported catalyst obtained by the above-mentioned method and 75% by mass aqueous t-butanol solution were introduced into a continuous type autoclave and a reaction for synthesizing methacrylic acid through liquid-phase oxidation reaction of isobutylene in a suspended bed was carried out in the same condition as in the evaluation of the fresh catalyst by a batchwise reaction till the conversion of isobutylene reached 50% of the conversion of isobutylene in the early stage of the reaction. Subsequently, the spent catalyst was drawn out, filtrated, separated, and air dried.

### (Evaluation of Physical Properties of a Spent Catalyst)

Evaluation of physical properties of a spent catalyst deteriorated by the continuous reaction was carried out by the above-mentioned methods. The Te/Pd in the surface layer of the catalyst was 0.33 and the average particle diameter of metals in the catalyst was 7.4 nm.

### Example 1

### Regeneration Treatment of a Catalyst

Calcination treatment of 3.0 parts of the spent catalyst obtained by the continuous reaction in Reference Example 1 was carried out at 350° C. for 3 hours in air. To a calcined material thus obtained, 10 parts of 37% by mass aqueous formaldehyde solution was added. The resultant mixture was subjected to reduction treatment by being heated to 70° C. and held at the same temperature for 2 hours while stirred. Subsequently, the resultant mixture was filtrated under suction and washed with pure water to obtain a palladium-containing metal supported catalyst to which regeneration treatment had been subjected.

(Evaluation of Physical Properties of a Catalyst to which Regeneration Treatment Had been Subjected)

Evaluation of physical properties of a catalyst to which the regeneration treatment had been subjected was carried out using the aforementioned methods. The Te/Pd in the surface layer of the catalyst was 0.19 and the average particle diameter of metals in the catalyst was 5.0 nm.

### (Evaluation by a Batchwise Reaction)

The same procedure as in the evaluation by a batchwise reaction in Reference Example 1 was carried out except that the reaction time was changed to 120 minutes. The results are shown in Table 1.

### Example 2

### Regeneration Treatment of a Catalyst

The same procedure as in Example 1 was carried out except that the calcination treatment was carried out at 400° C. in air.

(Evaluation of Physical Properties of a Catalyst to which Regeneration Treatment Had been Subjected)

Evaluation of physical properties of a catalyst to which the regeneration treatment had been subjected was carried out using the aforementioned methods. The Te/Pd in the surface layer of the catalyst was 0.17 and the average particle diameter of metals in the catalyst was 4.9 nm.

### (Evaluation by a Batchwise Reaction)

The same procedure as in Example 1 was carried out. The results are shown in Table 1.

### Example 3

### Regeneration Treatment of a Catalyst

The same procedure as in Example 1 was carried out except that the calcination treatment was carried out at 200° C. in air.

(Evaluation of Physical Properties of a Catalyst to which Regeneration Treatment Had been Subjected)

Evaluation of physical properties of a catalyst to which the regeneration treatment had been subjected was carried out using the aforementioned methods. The Te/Pd in the surface layer of the catalyst was 0.27 and the average particle diameter of metals in the catalyst was 5.9 nm.

### (Evaluation by a Batchwise Reaction)

The same procedure as in Example 1 was carried out. The results are shown in Table 1.

### Comparative Example 1

### Evaluation by a Batchwise Reaction

The same procedure as in Example 1 was carried out except that the spent catalyst used in the continuous reaction in Reference Example 1 was used as the catalyst. The results are shown in Table 1.

TABLE 1

| | | Average particle | | | |
|---|---|---|---|---|---|
| | Surface layer | diameter of | | Selectivity to | Productivity of |
| | (Te/Pd) | metals | Reaction time | methacrylic acid | methacrylic acid |
| | (molar ratio) | (nm) | (minute) | (%) | (g-MMA/g-Pd · h) |
| Reference Ex. 1 | 0.21 | 4.8 | 77 | 32.9 | 3.93 |
| (Fresh catalyst) | | | | | |
| Example 1 | 0.19 | 5.0 | 120 | 43.3 | 4.21 |
| Example 2 | 0.17 | 4.9 | 120 | 41.5 | 4.02 |
| Example 3 | 0.27 | 5.9 | 120 | 28.2 | 2.17 |
| Comp. Ex. 1 | 0.33 | 7.4 | 120 | 18.6 | 0.46 |

As mentioned above, the catalyst regenerated by the method of the present invention had high productivity of an α,β-unsaturated carboxylic acid. In particular, the catalysts regenerated by the method of Examples 1 and 2, in which the temperature of calcination treatment was 250 to 450° C., had about the same productivity of the α,β-unsaturated carboxylic acid as the fresh catalyst.

### Reference Example 2

### Preparation of a Fresh Catalyst

To 215.8 parts of palladium (II) nitrate nitric acid solution in which palladium content is 23.14% by mass, which is equivalent to 50 parts of palladium, 0.36 part of telluric acid dissolved in a small amount of pure water and 500 parts of pure water were added to prepare a mixed solution, in which a charging molar ratio of Te/Pd was 0.05. In the above-mentioned mixed solution, 250 parts of a silica carrier having a specific surface area of 450 m²/g and a pore volume of 0.68 cc/g were soaked, and the catalyst-dispersing medium of the aqueous nitric acid solution was evaporated at 40° C. for 3 hours under reduced a pressure using an evaporator. Subsequently, heat treatment of 200° C. for 3 hours in air was carried out. To a catalyst precursor thus obtained, 500 parts of 37% by mass aqueous formaldehyde solution was added. The resultant mixture was heated to 70° C., held at the same temperature for 2 hours while stirred, filtrated under suction, and washed with pure water to obtain a fresh palladium-containing metal supported catalyst. Palladium loading ratio of this catalyst was 20% by mass.

### (Evaluation of Physical Properties of a Fresh Catalyst)

Evaluation of physical properties of a fresh catalyst was carried out using the aforementioned methods. The Te/Pd in the surface layer of the catalyst was 0.07, the average particle diameter of metals in the catalyst was 4.7 nm, and the relative deviation of influence sphere of metal particles was 90.0%.

### (Evaluation by a Batchwise Reaction)

To an autoclave, 0.6 part of the fresh palladium-containing metal supported catalyst obtained by the above-mentioned method and 100 parts of 75% by mass aqueous t-butanol solution as a reaction solvent were added, and the autoclave was shut tight. Subsequently, 8.4 parts of isobutylene was introduced, and stirring of the resultant mixture was started at a number of revolution of 1,000 rpm and a temperature of the mixture was raised to 110° C. After the raising of the temperature was completed, nitrogen was introduced into the autoclave to the internal pressure of 2.4 MPa and then compressed air was introduced into the autoclave to the internal pressure of 4.8 MPa. Each time when the internal pressure dropped by 0.1 MPa, the internal pressure at this time being 4.7 MPa, oxygen was introduced into the autoclave by 0.1 MPa, and this operation was repeated during the reaction. The internal pressure right after the introduction of oxygen was 4.8 MPa. After the eleventh introduction of oxygen, when the internal pressure dropped by 0.15 MPa, the reaction was finished. At this time, the reaction time was 203 minutes.

After the reaction was finished, the inside of the autoclave was cooled in an ice bath. A gas-sampling bag was attached to a gas outlet of the autoclave and the gas outlet was opened and emerging gas was collected while the internal pressure of the reactor was released. The reaction liquid containing catalyst was taken out from the autoclave and the catalyst was separated by membrane filter and only the reaction liquid was recovered. The recovered reaction liquid and the collected gas were analyzed with gas chromatography. The results are shown in Table 2.

### (Continuous Reaction)

The above-mentioned evaluation of the reaction was carried out in a batchwise manner for a short time, so that the catalyst is deteriorated only slightly. Therefore, the reaction was carried out in a continuous manner and a spent catalyst of this reaction was used for the evaluation in order to clarify regeneration effect of the catalyst. The method for reaction in the continuous manner is as follows.

A fresh palladium-containing metal supported catalyst obtained by the above-mentioned method and 75% by mass aqueous t-butanol solution were introduced into a continuous type autoclave and a reaction for synthesizing methacrylic acid through liquid-phase oxidation reaction of isobutylene in a suspended bed was carried out in the same condition as in the evaluation of the fresh catalyst by a batchwise reaction till the conversion of isobutylene reached 50% of the conversion of isobutylene in the early stage of the reaction. Subsequently, the deteriorated spent catalyst was drawn out, filtrated, separated, and air-dried.

### (Evaluation of Physical Properties of a Spent Catalyst)

Evaluation of physical properties of a spent catalyst deteriorated by the continuous reaction was carried out by the above-mentioned methods. The Te/Pd in the surface layer of the catalyst was 0.08, the average particle diameter of metals in the catalyst was 5.8 nm, and the relative deviation of influence sphere of metal particles was 95.8%.

### Example 4

### Regeneration Treatment of a Catalyst

The spent catalyst obtained by the continuous reaction in Reference Example 2 was dried prior to regeneration treatment. Subsequently, 1 part of 61% by mass aqueous nitric acid solution was added to 0.6 part of the spent catalyst, and the resultant mixture was subjected to nitric acid treatment by being heated to 60° C. and held at the same temperature for 2 hours while stirred. Subsequently, the catalyst-dispersing medium of the aqueous nitric acid solution was evaporated at 60° C. for 3 hours under a reduced pressure using an evaporator. Subsequently, calcination treatment of the resultant material was carried out at 350° C. for 3 hours in air. To a calcination-treated material thus obtained, 10 parts of 37% by mass aqueous formaldehyde solution was added and the resultant mixture was subjected to reduction treatment by being heated to 70° C. and held at the same temperature for 2 hours while stirred. Subsequently, the resultant mixture was filtrated under suction and washed with pure water to obtain a palladium-containing metal supported catalyst to which regeneration treatment had been subjected.

(Evaluation of Physical Properties of a Catalyst to which Regeneration Treatment Had been Subjected)

Evaluation of physical properties of a catalyst to which the regeneration treatment had been subjected was carried out using the aforementioned methods. The Te/Pd in the surface layer of the catalyst was 0.06, the average particle diameter of metals in the catalyst was 3.9 nm, and the relative deviation of influence sphere of metal particles was 85.7%.

### (Evaluation by a Batchwise Reaction)

The same procedure as in the evaluation by a batchwise reaction in Reference Example 2 was carried out except that the catalyst to which the above-mentioned regeneration treatment had been subjected was used. The results are shown in Table 2.

### Example 5

### Regeneration Treatment of a Catalyst

The same procedure as in Example 4 was carried out except that the calcination treatment was carried out at 200° C.

(Evaluation of Physical Properties of a Catalyst to which Regeneration Treatment Had been Subjected)

Evaluation of physical properties of a catalyst to which the regeneration treatment had been subjected was carried out using the aforementioned methods. The Te/Pd in the surface layer of the catalyst was 0.07, the average particle diameter of metals in the catalyst was 4.2 nm, and the relative deviation of influence sphere of metal particles was 86.4%.

### (Evaluation by a Batchwise Reaction)

The same procedure as in the evaluation by a batchwise reaction in Reference Example 2 was carried out except that the catalyst to which the above-mentioned regeneration treatment had been subjected was used. The results are shown in Table 2.

### Example 6

### Regeneration Treatment of a Catalyst

The same procedure as in Example 5 was carried out except that aqua regia treatment was carried out using aqua regia instead of 61% by mass aqueous nitric acid solution and calcination treatment was carried out at 600° C.

(Evaluation of Physical Properties of a Catalyst to which Regeneration Treatment Had been Subjected)

Evaluation of physical properties of a catalyst to which the regeneration treatment had been subjected was carried out using the aforementioned methods. The Te/Pd in the surface layer of the catalyst was 0.07, the average particle diameter of metals in the catalyst was 4.0 nm, and the relative deviation of influence sphere of metal particles was 84.1%.

### (Evaluation by a Batchwise Reaction)

The same procedure as in the evaluation by a batchwise reaction in Reference Example 2 was carried out except that the catalyst to which the above-mentioned regeneration treatment had been subjected was used. The results are shown in Table 2.

### Example 7

### Regeneration Treatment of a Catalyst

The same procedure as in Example 4 was carried out except that the calcination treatment was carried out at 600° C.

(Evaluation of Physical Properties of a Catalyst to which Regeneration Treatment Had been Subjected)

Evaluation of physical properties of a catalyst which the regeneration treatment had been subjected was carried out using the aforementioned methods. The Te/Pd in the surface layer of the catalyst was 0.07, the average particle diameter of metals in the catalyst was 4.2 nm, and the relative deviation of influence sphere of metal particles was 86.6%.

### (Evaluation by a Batchwise Reaction)

The same procedure as in the evaluation by a batchwise reaction in Reference Example 2 was carried out except that the catalyst to which the above-mentioned regeneration treatment had been subjected was used. The results are shown in Table 2.

### Comparative Example 2

### Regeneration Treatment of a Catalyst

The same procedure as in Example 4 was carried out except that the calcination treatment was not carried out.

(Evaluation of Physical Properties of a Catalyst to which Regeneration Treatment Had been Subjected)

Evaluation of physical properties of a catalyst to which the above-mentioned regeneration treatment had been subjected was carried out. The Te/Pd in the surface layer of the catalyst was 0.08, the average particle diameter of metals in the catalyst was 4.6 nm, and the relative deviation of influence sphere of metal particles was 99.5%.

### (Evaluation by a Batchwise Reaction)

The same procedure as in the evaluation by a batchwise reaction in Reference Example 2 was carried out except that the catalyst to which the above-mentioned regeneration treatment had been subjected was used. The results are shown in Table 2.

### Comparative Example 3

### Regeneration Treatment of a Catalyst

The same procedure as in Example 4 was carried out except that the calcination treatment was carried out at 120° C.

(Evaluation of Physical Properties of a Catalyst to which Regeneration Treatment Had been Subjected)

Evaluation of physical properties of a catalyst to which the regeneration treatment had been subjected was carried out using the aforementioned methods. The Te/Pd in the surface layer of the catalyst was 0.07, the average particle diameter of metals in the catalyst was 4.5 nm, and the relative deviation of influence sphere of metal particles was 96.2%.

### (Evaluation by a Batchwise Reaction)

The same procedure as in the evaluation by a batchwise reaction in Reference Example 2 was carried out except that the catalyst to which the above-mentioned regeneration treatment had been subjected was used. The results are shown in Table 2.

TABLE 2

| | | Average particle | Relative deviation | | | |
|---|---|---|---|---|---|---|
| | Surface layer | diameter of | of influence sphere | Reaction | Selectivity to | Productivity of |
| | (Te/Pd) | metals | of metal particles | time | methacrylic acid | methacrylic acid |
| | (molar ratio) | (nm) | (%) | (minute) | (%) | (g-MMA/g-Pd · h) |
| Reference Ex. 2 | 0.07 | 4.7 | 90.0 | 203 | 25.5 | 5.41 |
| (Fresh catalyst) | | | | | | |
| Reference Ex. 2 | 0.08 | 5.8 | 95.8 | 313 | 22.8 | 2.92 |
| (Continuous reaction) | (After reaction) | (After reaction) | (After reaction) | | | |
| Example 4 | 0.06 | 3.9 | 85.7 | 137 | 25.2 | 8.15 |
| Example 5 | 0.07 | 4.2 | 86.4 | 190 | 27.9 | 6.09 |
| Example 6 | 0.07 | 4.0 | 84.1 | 176 | 24.9 | 6.15 |
| Example 7 | 0.07 | 4.2 | 86.6 | 185 | 25.0 | 6.83 |
| Comp. Ex. 2 | 0.08 | 4.6 | 99.5 | 252 | 23.0 | 4.98 |
| Comp. Ex. 3 | 0.07 | 4.5 | 96.2 | 243 | 23.4 | 5.06 |

As mentioned above, according to the present invention, a palladium-containing metal supported catalyst which has been used for production of an α,β-unsaturated carboxylic acid from an olefin or an α,β-unsaturated aldehyde can be regenerated and activated to a catalyst having such a productivity of the α,β-unsaturated carboxylic acid as high as a fresh catalyst or higher.

1. A method for regenerating a palladium-containing metal supported catalyst which has been used for production of an α,β-unsaturated carboxylic acid by oxidation of an olefin or an α,β-unsaturated aldehyde with molecular oxygen in a liquid phase, the method comprising:
calcining the palladium-containing metal supported catalyst at a temperature in a range of from 150 to 700° C. in the presence of molecular oxygen to convert at least a part of palladium into palladium oxide; and
reducing the palladium oxide thus obtained from said calcining.

2. The method according to claim 1, wherein the temperature of calcination treatment during said calcining is in a range of from 250 to 450° C.

3. The method according to claim 1, wherein a temperature of reduction treatment during said reducing is in a range of from −5 to 150° C.

4. A method for regenerating a palladium-containing metal supported catalyst which has been used for production of an α,β-unsaturated carboxylic acid by oxidation of an olefin or an α,β-unsaturated aldehyde with molecular oxygen in a liquid phase, the method comprising:
subjecting the palladium-containing metal supported catalyst to a mineral acid treatment;
calcining the palladium-containing metal supported catalyst thus treated in the mineral acid treatment at a temperature in a range of from 150 to 700° C. in the presence of molecular oxygen; and
reducing a palladium oxide thus obtained from said calcining.

5. The method according to claim 4, wherein the temperature of calcination treatment during said calcining is in a range of from 250 to 450° C.

6. The method according to claim 4, wherein a temperature of reduction treatment during said reducing is in a range of from −5 to 150° C.

7. A method for producing a palladium-containing metal supported catalyst to be used for production of an α,β-unsaturated carboxylic acid by oxidation of an olefin or an α,β-unsaturated aldehyde with molecular oxygen in a liquid phase, the method comprising regenerating a palladium-containing metal supported catalyst using the method according to claim 1.

8-9. (canceled)

10. A palladium-containing metal supported catalyst for production of an α,β-unsaturated carboxylic acid by oxidation of an olefin or an α,β-unsaturated aldehyde with molecular oxygen in a liquid phase, in which a relative deviation of influence sphere of metal particles being supported on a carrier is 88% or less.

11. The method according to claim 2, wherein a temperature of reduction treatment during said reducing is in a range of from −5 to 150° C.

12. The method according to claim 5, wherein a temperature of reduction treatment during said reducing is in a range of from −5 to 150° C.

13. A method for producing a palladium-containing metal supported catalyst to be used for production of an α,β-unsaturated carboxylic acid by oxidation of an olefin or an α,β-unsaturated aldehyde with molecular oxygen in a liquid phase, the method comprising regenerating a palladium-containing metal supported catalyst using the method according to claim 4.

14. A palladium-containing metal supported catalyst to be obtained by the method for producing a palladium-containing metal supported catalyst according to claim 13, in which a relative deviation of influence sphere of metal particles supported on a carrier is 88% or less.
